(19) United States
(12) Patent Application Publication
(10) Pub. No.: US 2011/0141755 A1
(43) Pub. Date: Jun. 16, 2011

(54) VEHICLE LAMP

(76) Inventors: Tadao Tsukagoshi, Tokyo (JP); Ryoji Konoki, Tokyo (JP); Yuta Takahashi, Tokyo (JP)

(21) Appl. No.: 12/948,741

(22) Filed: Nov. 17, 2010

(30) Foreign Application Priority Data
Nov. 17, 2009 (JP) 2009-261431

(51) Int. Cl. B60Q 1/04; B23P 11/00

(52) U.S. Cl. 362/539; 29/428

(57) ABSTRACT

A vehicle lamp can include a light source, a first reflector and a second reflector configured to reflect light from the light source, a convex lens disposed in front of the first reflector, and a shade configured to partially shield the light reflected by the first reflector. One component (e.g., second reflector) out of the first reflector, the second reflector and the shade can be assembled to be brought into contact with another component (e.g., shade) out of the first reflector, the second reflector and the shade at respective contact areas of the one component and the other component according to a particular specification. The second reflector and the shade can have corresponding erroneous-assembly prevention members at corresponding positions of respective contact areas, respectively, so that a different second reflector according to a different specification can be prevented from mating with the shade according to the particular specification, and a different shade according to a different specification is prevented from mating with the second reflector according to the particular specification.

This application claims the priority benefit under 35 U.S.C. §119 of Japanese Patent Application No. 2009-261431 filed on Nov. 17, 2009, which is hereby incorporated in its entirety by reference.

### TECHNICAL FIELD

The presently disclosed subject matter relates to a vehicle lamp, and specifically to a vehicle headlamp having first and second reflectors and a shade.

### BACKGROUND ART

Conventional vehicle headlamps have included a shade for shielding light that is directed from a light source to an opposite/oncoming vehicle in order to prevent or suppress the occurrence of “glare light” to a driver of the opposite/oncoming vehicle(s) or pedestrian(s). (See, for example, Japanese Patent Application Laid-Open Nos. 2000-149638 (or U.S. Pat. No. 6,471,384B1 corresponding to this JP application) and 2008-098030.) One example thereof can include a light source, a first reflector and a second reflector for reflecting light from the light source, and a shade for partially shielding light reflected by the first reflector.

Such a vehicle headlamp can be designed according to an intended purpose, specification, and the like, and in particular, can have first and second reflectors and a shade in respective different shapes depending on the intended specification for each user. For example, one type of first reflector, two types of second reflectors, and two types of shades can be prepared to constitute two different types of vehicle headlamps.

In this case, because of the existence of the two types of the second reflectors and the two types of the shades, these structures may be erroneously combined during assembly and delivered to a user without correcting this fault.

### SUMMARY

The presently disclosed subject matter was devised in view of these and other problems and features and in association with the conventional art. Thus, according to an aspect of the presently disclosed subject matter, a vehicle headlamp can be provided to prevent the erroneous assembly due to different specifications.

According to another aspect of the presently disclosed subject matter, a vehicle headlamp can include: a light source; a first reflector and a second reflector configured to reflect light from the light source; a convex lens disposed in front of the first reflector; a shade configured to partially shield the light reflected by the first reflector. In this vehicle headlamp, one component out of the first reflector, the second reflector and the shade can be assembled to be brought into contact with another component out of the first reflector, the second reflector and the shade at respective contact areas of the one component and the other component. Furthermore, the vehicle headlamp can be designed according to a plurality of specifications so as to form the one component and the other component as a set according to a particular specification among the specifications. Here, the one component and the other component can have corresponding erroneous-assembly prevention members at corresponding positions of the respective contact areas, respectively, so that a different component according to a different specification is prevented from mating to the other component according to the particular specification and a different other component according to a different specification is prevented from mating to the one component according to the particular specification.

In the above-mentioned vehicle headlamp, the one component can be the shade and the other component can be the second reflector, for example.

In the above-mentioned vehicle headlamp, one of the erroneous-prevention members can be a projection and the other of the erroneous-prevention members can be a concave portion for receiving the projection.

Furthermore, in the above-mentioned vehicle headlamp, the plurality of specifications can include a first specification and a second specification. In this case, the one component can be the shade selected from an A shade according to the first specification and a B shade according to the second specification, and the other component can be the second reflector selected from an A second reflector according to the first specification and a B second reflector according to the second specification while the erroneous-assembly prevention members can include a projection and a concave portion for receiving the projection as a set. In this configuration, the projection can be formed in one of the A shade and the A second reflector at a first position and the concave portion can be formed in the other of the A shade and the A second reflector at a first position corresponding to the first position of the projection so that the A shade and the A second reflector can mate to each other by allowing the projection to be received by the concave portion. Furthermore, the projection can be formed in one of the B shade and the B second reflector at a second position and the concave portion can be formed in the other of the B shade and the B second reflector at a second position corresponding to the second position of the projection so that the B shade and the B second reflector can mate to each other by allowing the projection to be received by the concave portion. Accordingly, the A shade and the B second reflector can be prevented from mating with each other and the B shade and the A second reflector can be prevented from mating with each other because of the displaced relationship between the projection and the concave portion.

Accordingly, a vehicle headlamp made in accordance with the principles of the presently disclosed subject matter can be assembled by combining the first reflector with a particular shade and a corresponding second reflector having respective erroneous-assemble prevention members at respective corresponding positions. In this case, when a first unit including the shade according to a particular specification is attempted to be assembled to a second unit including a second reflector according to a different specification, the erroneous-assemble prevention members of these components cannot be matched to each other because of different positional relationships. Accordingly, a person in charge can recognize that the first unit and the second unit each have different corresponding components which are made according to different specifications. If there are no erroneous-assembly prevention members formed in the components, the different components can be assembled without doubt, so that the resulting vehicle headlamp may be made according to an erroneous specification and delivered to a user. The vehicle headlamp made in accordance with the principles of the presently disclosed subject matter can solve as well as other problems.

### BRIEF DESCRIPTION OF DRAWINGS

These and other characteristics, features, and advantages of the presently disclosed subject matter will become clear from the following description with reference to the accompanying drawings, wherein:

FIG. 1 is a side view of a vehicle headlamp made in accordance with principles of the presently disclosed subject matter;

FIGS. 2A, 2B, and 2C are perspective views illustrating assembly processes for the vehicle headlamp of FIG. 1;

FIGS. 3A, 3B, and 3C are perspective views illustrating assembly processes for the vehicle headlamp of FIG. 1; and

FIG. 4 is a table illustrating combinations of the first and second reflectors and the shade of the vehicle headlamp of FIG. 1.

### DESCRIPTION OF EXEMPLARY EMBODIMENTS

A description will now be made below to vehicle headlamps of the presently disclosed subject matter with reference to the accompanying drawings in accordance with exemplary embodiments.

It should be noted that in the present specification, the directions with regard to the “up,” “down,” “right,” “left,” “front,” and “rear” and the like may be based on the case where the vehicle light is installed in a vehicle body. Namely, the directions may be considered to match to the vertical direction (up-to-down direction), the lateral direction (right-to-left or vehicle width direction), and the front-to-rear direction of the vehicle body.

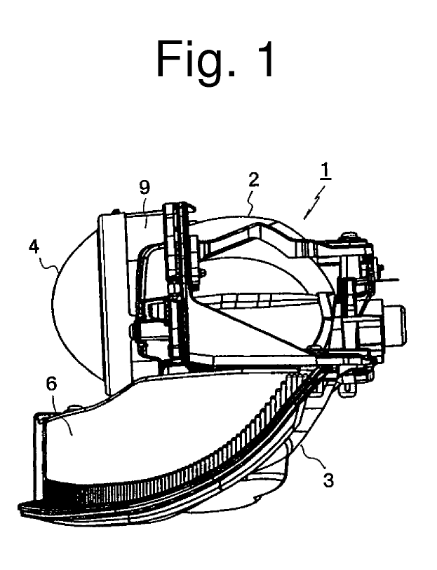

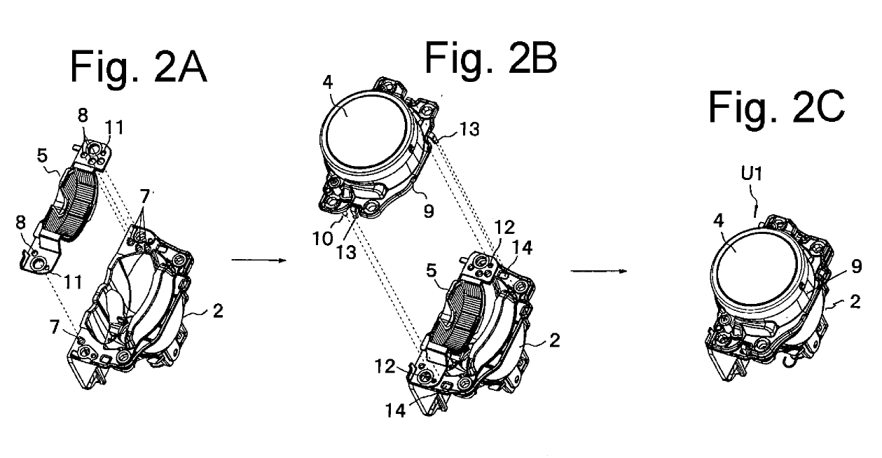

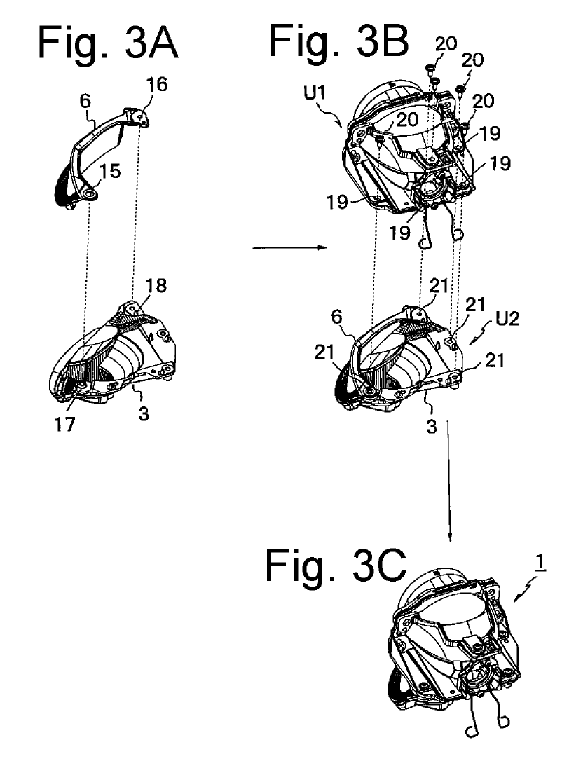

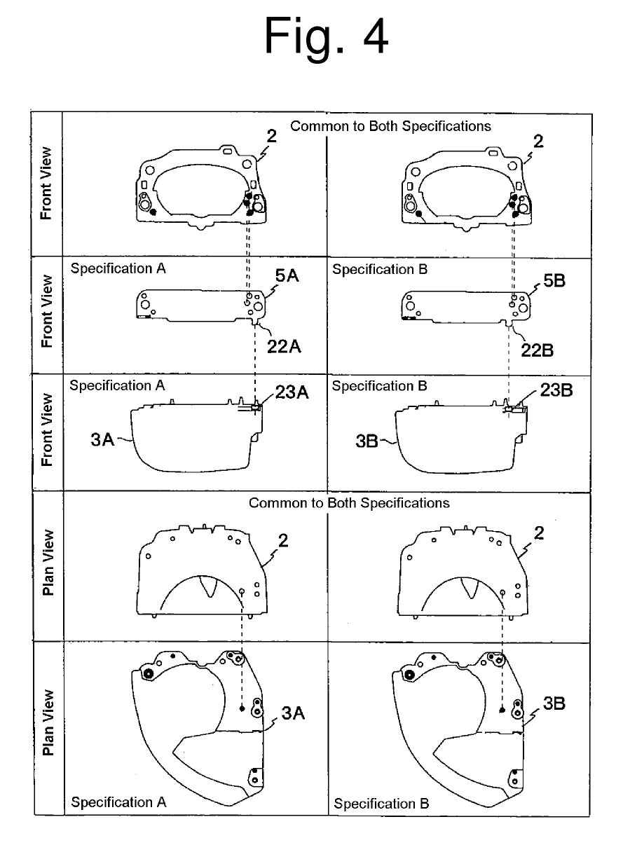

FIG. 1 is a side view of a vehicle headlamp made in accordance with principles of the presently disclosed subject matter. FIGS. 2A, 2B, and 2C and 3A, 3B, and 3C are perspective views illustrating assembly processes for the vehicle headlamp. Furthermore, FIG. 4 is a table illustrating combinations of the first and second reflectors and the shade of the vehicle headlamp. The vehicle headlamp of FIG. 1 is configured to be mounted on both right and left front areas of a vehicle body (not shown), and accordingly, the configuration of the right vehicle headlamp is symmetric to that of the left one. Hereinafter, one of them is illustrated.

The vehicle headlamp 1 according to the present exemplary embodiment can include a light source (not shown), a first reflector 2 (see FIGS. 1 and 2) and a second reflector 3 (see FIGS. 1 and 3) configured to reflect light from the light source, a convex lens 4 disposed in front of the first reflector 2, a shade 5 (see FIG. 2) configured to partially shield the light reflected by the first reflector 2, an inner lens 6 disposed in front of the second reflector 3 so as to cover the front side of the second reflector 3, and a holder 9 for holding the lens 4.

The assembly processes for the vehicle headlamp 1 having the above components will be described with reference to FIGS. 2A to 2C and 3A to 3C.

First, as shown in FIG. 2A, the first reflector 2 can have a mating face on which four positioning pins 7 are formed to project toward the shade 5 while the shade can have a mating face in which four circular positioning holes 8 are formed. In this case, the mating face of the reflector 2 (or shade 5) can be formed by right and left mating faces each having two of the four positioning pins 7 (or holes 8). The first reflector 2 and the shade 5 can be assembled by inserting the positioning pins 7 of the reflector 2 into the positioning holes 8 of the shade 5, thereby achieving the positioning between the first reflector 2 and the shade 5 as shown in FIG. 2B.

Next, as shown in FIG. 2B, the holder 9 can hold the convex lens 4 by its surrounding portion where two positioning pins 10 are formed on both right and left sides (only one of the pins 10 can be observed in FIG. 2B). Further, two right and left circular positioning holes 11 can be formed in the mating faces of the shade 5, respectively (see FIG. 2A), and two right and left circular positioning holes 12 can be formed in the mating faces of the first reflector 7, respectively (see FIG. 2B). The holder 9 can be positioned with respect to the shade 5 and the first reflector 2 by inserting the two positioning pins 10 of the holder 9 into the two positioning holes 11 of the shade 5 and the two positioning holes 12 of the reflector 2. The holder 9 can have a pair of hooks 13 that project from its right and left sides and the first reflector 2 can have a pair of rectangular engaging holes 14 formed on its right and left sides. The hooks 13 of the holder 9 can be allowed to be engaged with the engaging holes 14 of the first reflector 2, thereby assembling a first unit U1 integrally including the holder 9 holding the convex lens 4, the shade 5 and the first reflector 2 as shown in FIG. 2C.

On the other hand, the inner lens 6 can have two circular positioning holes 15 and 16 formed on its right and left sides as shown in FIG. 3A. The second reflector 3 can have a mating face on which a positioning boss 17 and a positioning pin 18 are formed to project toward the lens 6. The inner lens 6 and the second reflector 3 can be positioned and temporality fixed by inserting the positioning boss 17 and pin 18 into the respective positioning holes 15 and 16, thereby assembling a second unit U2 as shown in the lower portion of FIG. 3B.

Next, the first reflector 2 can have on its surrounding edge area four circular screw insertion holes 19 while the second reflector 3 can have on its surrounding edge area four screw holes 21. Then, four screws 20 can be inserted through the four screw insertion holes 19 of the first reflector 2 and screwed into the four screw holes 21 of the second reflector 3, thereby uniting the first unit U1 and the second unit U2 together and completing the assembly processes for the vehicle headlamp 1.

When these components each include several choices, various vehicle headlamps can be formed by combining various components according to a particular specification or specific application for the lamp. In the present exemplary embodiment, if we take into consideration the case as shown in Table of FIG. 4 where the first reflector 2 includes one type (common to Specifications A and B), the shade 5 include two types of shades 5A and 5B (according to Specification A and Specification B, respectively), and the second reflector 3 includes two types of reflectors 3A and 3B (according to Specification A and Specification B, respectively), then two types of vehicle headlamps 1A and 1B can be manufactured according to Specification A and Specification B, respectively. In this case, there may be a problem in which the vehicle headlamp 1 may be erroneously manufactured by assembling the shade 5A (Specification A) with the second reflector 3B (Specification B) or vice versa. In this case, the assembled vehicle headlamp 1 cannot satisfy either Specification A or B.

In view of this, according to the presently disclosed subject matter, the components that may be designed according to different specifications can have erroneous-assembly prevention members included as a set. In the present exemplary embodiment, as shown in the Table of FIG. 4, the shade 5A (5B) that is designed according to one of different specifications can have an erroneous-assembly prevention rib 22A (22B) formed on a contact face that is to be brought into contact with a counter component, i.e., the second reflector 3A (3B) that is also designed according to the corresponding specification. Furthermore, the counter component, i.e., the second reflector 3A (3B) can have on a contact face a concave portion 23A (23B) configured to receive only the corresponding erroneous-assembly prevention rib 22A (22B). In this case, the rib 22A and the concave portion 23A according to Specification A can be formed at different positions from the positions where the rib 22B and the concave portion 23B according to Specification B are formed. Namely, a set of erroneous-assembly prevention members are formed at the same corresponding positions of the respective counter components according to a particular specification while other sets according to different specifications are formed at different positions from the set of erroneous-assembly prevention members.

Accordingly, in the present exemplary embodiment, the vehicle headlamps 1A and 1B can be assembled by combining the first reflector 2 of one type with one of the two shades 5A and 5B and one of the two second reflectors 3A and 3B. In this case, when the unit U1 including the shade 5A according to Specification A is tried to be assembled to the unit U2 including the second reflector 3B according to Specification B, the concave portion 23B cannot receive the rib 22A because of different position. Accordingly, a person in charge can recognize that the unit U1 and the unit U2 each have a different corresponding component according to a different specification. If there are no erroneous-assembly prevention members formed in the required components, the different components are assembled, so that the resulting vehicle headlamp is made according to an erroneous specification and delivered to a user. The vehicle headlamp of the present exemplary embodiment can solve this problem.

In the above exemplary embodiment, the shade 5 includes the erroneous-assembly prevention rib and the second reflector 3 includes the corresponding concave portion. However, the presently disclosed subject matter is not limited to this, and the shade 5 can include a concave portion and the reflector 3 can include a rib to be received by the concave portion of the shade 5.

In the above exemplary embodiment, the erroneous-assembly prevention members are achieved by a set of a simple rib and a simple concave portion at the corresponding positions on corresponding respective components. However, the presently disclosed subject matter is not limited to this particular embodiment, and the erroneous-assembly prevention members can be formed by a set of a projection and a concave portion with various shapes as long as they can mate with each other when formed at corresponding positions but are prevented from mating when formed at respective different positions. The structures that include the projection member and concave portion can also be reversed without departing from the spirit and scope of the disclosure.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A vehicle headlamp, comprising:
a light source;
a first reflector and a second reflector configured to reflect light from the light source;
a convex lens disposed in front of the first reflector;
a shade configured to partially shield the light reflected by the first reflector, wherein
one component out of the first reflector, the second reflector and the shade is configured to be brought into contact with an other component out of the first reflector, the second reflector and the shade at respective contact areas of the one component and the other component;
the vehicle headlamp is configured to include a plurality of specifications so as to form the one component and the other component as a set according to a particular specification among the specifications; and
the one component and the other component have corresponding erroneous-assembly prevention members at corresponding positions of the respective contact areas, respectively, so that a different component configured according to a different specification is prevented from mating with the other component according to the particular specification and a different other component configured according to a different specification is prevented from mating with the one component according to the particular specification.

2. The vehicle headlamp according to claim 1, wherein the one component is the shade and the other component is the second reflector.

3. The vehicle headlamp according to claim 1, wherein one of the erroneous-prevention members is a projection and an other of the erroneous-prevention members is a concave portion for receiving the projection.

4. The vehicle headlamp according to claim 2, wherein one of the erroneous-prevention members is a projection and an other of the erroneous-prevention members is a concave portion for receiving the projection.

5. The vehicle headlamp according to claim 1, wherein:
the plurality of specifications includes a first specification and a second specification;
the one component is the shade selected from an A shade according to the first specification and a B shade according to the second specification;
the other component is the second reflector selected from an A second reflector according to the first specification and a B second reflector according to the second specification;
the erroneous-assembly prevention members include a projection and a concave portion for receiving the projection as a set;
the projection is formed in one of the A shade and the A second reflector at a first position and the concave portion is formed in the other of the A shade and the A second reflector at a position corresponding to the first position of the projection so that the A shade and the A second reflector can mate with each other;
another projection is formed in one of the B shade and the B second reflector at a second position and another concave portion is formed in the other of the B shade and the B second reflector at another position corresponding to the second position of the another projection so that the B shade and the B second reflector can mate with each other; and
the respective projection and concave portion of the A shade and the B second reflector are configured such that the A shade and the B second reflector are prevented from mating with each other, and the respective projection and concave portion of the B shade and the A second reflector are configured such that the B shade and the A second reflector are prevented from mating with each other.

6. A method for making a vehicle lamp, comprising:
providing a light source, a first reflector and a second reflector configured to reflect light from the light source, a convex lens disposed in front of the first reflector, and a shade configured to partially shield the light reflected by the first reflector, wherein one component out of the first reflector, the second reflector, and the shade is configured to be brought into contact with an other component out of the first reflector, the second reflector, and the shade at respective contact areas of the one component and the other component;
forming the one component and the other component as a set according to a particular specification among a plurality of specifications;
providing the one component and the other component with corresponding erroneous-assembly prevention members at corresponding positions of the respective contact areas, respectively;
preventing a different component configured according to a different specification from mating with the other component according to the particular specification; and
preventing a different other component configured according to a different specification from mating with the one component according to the particular specification.

7. The method for making a vehicle lamp according to claim 6, wherein
providing the one component and the other component with corresponding erroneous-assembly prevention members includes providing the one component with a projection and the other component with a concave portion for receiving the projection when the one component is assembled with the other component.

8. The method for making a vehicle lamp according to claim 7, wherein
preventing a different component configured according to a different specification from mating with the other component according to the particular specification includes providing the different component with an erroneous-assembly prevention member that prevents the different component from mating with the other component.

9. The method for making a vehicle lamp according to claim 6, wherein
preventing a different component configured according to a different specification from mating with the other component according to the particular specification includes providing the different component with an erroneous-assembly prevention member that prevents the different component from mating with the other component.

10. A vehicle lamp assembly, comprising:
a light source;
a first reflector and a second reflector configured to reflect light from the light source;
a convex lens disposed in front of the first reflector;
a shade configured to partially shield the light reflected by the first reflector, wherein
one component out of the first reflector, the second reflector, and the shade is configured to be brought into contact with an other component out of the first reflector, the second reflector, and the shade at respective contact areas of the one component and the other component;
the vehicle lamp assembly includes a plurality of specifications of configuration such that the one component and the other component form a set according to a particular specification among the specifications;
the one component and the other component have corresponding erroneous-assembly prevention members at corresponding positions of the respective contact areas, respectively; and
a different component configured according to a different specification includes a different erroneous-assembly prevention member configured to prevent the different component from mating with the other component according to the particular specification.

11. The vehicle lamp assembly according to claim 10, further comprising:
a different other component configured according to the different specification and which includes a different erroneous-assembly prevention member configured to prevent the different other component from mating with the one component according to the particular specification.

12. The vehicle lamp assembly according to claim 10, wherein the one component is the shade and the other component is the second reflector.

13. The vehicle lamp assembly according to claim 10, wherein one of the erroneous-prevention members is a projection and an other of the erroneous-prevention members is a concave portion for receiving the projection.

14. The vehicle lamp assembly according to claim 12, wherein one of the erroneous-prevention members is a projection and an other of the erroneous-prevention members is a concave portion for receiving the projection.

15. The vehicle lamp assembly according to claim 10, wherein:
the plurality of specifications includes a first specification and a second specification;
the one component is the shade selected from an A shade according to the first specification and a B shade according to the second specification;
the other component is the second reflector selected from an A second reflector according to the first specification and a B second reflector according to the second specification;
the erroneous-assembly prevention members include a projection and a concave portion for receiving the projection as a set;
the projection is formed in one of the A shade and the A second reflector at a first position and the concave portion is formed in the other of the A shade and the A second reflector at a position corresponding to the first position of the projection so that the A shade and the A second reflector can mate with each other;
another projection is formed in one of the B shade and the B second reflector at a second position and the concave portion is formed in the other of the B shade and the B second reflector at another position corresponding to the second position of the projection so that the B shade and the B second reflector can mate with each other; and
the respective projection and concave portion of the A shade and the B second reflector are configured such that the A shade and the B second reflector are prevented from mating with each other, and the respective projection and concave portion of the B shade and the A second reflector are configured such that the B shade and the A second reflector are prevented from mating with each other.
